(19) United States
(12) Patent Application Publication
(10) Pub. No.: US 2011/0184088 A1
(43) Pub. Date: Jul. 28, 2011

(54) COATING MATERIALS COMPRISING COMPOSITE PARTICLES

(75) Inventors: Bas LOHMEIJER, Mannheim (DE); Oliver Wagner, Osthofen (DE); Ekkehard Jahns, Weinheim (DE)

(73) Assignee: BASF SE, Ludwigshafen (DE)

(21) Appl. No.: 13/012,273

(22) Filed: Jan. 24, 2011

Related U.S. Application Data
(60) Provisional application No. 61/298,567, filed on Jan. 27, 2010.

(30) Foreign Application Priority Data
Jan. 27, 2010 (EP) 10151764.7

(51) Int. Cl. C09D 133/08; C08K 3/34; C09D 5/16

(52) U.S. Cl. 523/177; 524/444; 524/556; 524/522

(57) ABSTRACT

The present invention relates to a coating material in the form of an aqueous composition comprising:
25% to 55% by weight of composite particles having an average particle size of 50 to 350 nm, in the form of an aqueous dispersion, which are constructed of
   20% to 60% by weight, based on the composite particle, of inorganic solid having an average particle size of 5 to 100 nm,
   40% to 80% by weight, based on the composite particle, of a polymer matrix having a T₉ in the range from −60 to +40° C. and obtainable by free-radical emulsion polymerization of at least one ethylenically unsaturated monomer, and
20% to 50% by weight of fillers, with 5% to 40% by weight, based on the total solids content, being selected from aluminum silicates, borosilicate glasses, polymethyl methacrylate particles, and polystyrene particles,
1% to 30% by weight of pigments, and
0% to 5% by weight of one or more thickeners
0.1% to 20% by weight of other auxiliaries
   based in each case on the total solids content, and also to the use thereof for coating surfaces, objects and substrates in permanent water contact, more particularly with swimming pool water.

The present invention relates to a coating material in the form of an aqueous composition comprising:
25% to 55% by weight of composite particles having an average particle size of 50 to 350 nm, in the form of an aqueous dispersion, which are constructed of
   20% to 60% by weight, based on the composite particle, of inorganic solid having an average particle size of 5 to 100 nm,
   40% to 90%, preferably 40% to 80%, by weight, based on the composite particle, of a polymer matrix having a T_{g} in the range from −60 to +40° C. and obtainable by free-radical emulsion polymerization of at least one ethylenically unsaturated monomer, and
20% to 50% by weight of fillers, with 5% to 40% by weight, based on the total solids content, being selected from aluminum silicates, borosilicate glasses, polymethyl methacrylate particles, and polystyrene particles,
1% to 30% by weight of pigments, and
0% to 5% by weight of one or more thickeners
0.1% to 20% by weight of other auxiliaries
   based in each case on the total solids content, and also to the use thereof for coating surfaces, objects, and substrates in permanent water contact, more particularly with swimming pool water.

Composite particles and processes for preparing them in the form of aqueous composite-particle dispersions, and the use thereof in paints, are known to the skilled worker and are described in, for example, the specifications EP-A 572 128, WO 0118081, WO 0129106 and WO 03000760. Furthermore, earlier European application 09157984.7 describes a process for preparing an aqueous dispersion of composite particles of ethylenically unsaturated monomers and finely divided silicon dioxide by a two-stage polymerization process.

Also known to the skilled worker is the use of composite-particle dispersions in wood-coating formulations, as for example when the aim is for a balanced compromise between the hardness of the coating, which ensures early blocking resistance on the part of the coating, and the elasticity of the coating, which secures effective stability for the coating on fluctuations in temperature. Hence WO 2008/009596 describes the use of an aqueous dispersion of composite particles of ethylenically unsaturated monomers and silicon dioxide as a binder in wood-coating formulations, which feature relatively low water permeability on the part of the wood coating.

The earlier European application 08163496.6 teaches the use of an aqueous composite-particle dispersion whose particles are constructed from ethylenically unsaturated monomers and finely divided silicon dioxide as a binder in elastic coating materials, such as paints, which combine enhanced elasticity and water resistance with high soil pick-up resistance and water-vapor permeability.

Although a masonry paint is already required to exhibit high water resistance, the requirements imposed on swimming pool paints are significantly higher. A masonry paint can always dry out again following exposure to moisture in the form, for example, of rain. And a masonry paint is normally not subject to any great mechanical loads. At least in the six months of summer, or in frost-free locations for the whole year, a swimming pool paint for painting a pool lining is exposed to the swimming pool water. Large parts of the pool liner are filled with water, and the paint is continuously covered with water. State of the art paints used currently are usually solventborne paints with a chlorinated rubber binder. This technology has been found to be resistant to some extent to the ongoing contact with water. Nowadays, however, there is increasing demand, for reasons of occupational hygiene or environmental compatibility, for low-solvent or solvent-free paints. Water-based paints with, for example, polymer dispersion binders, of the kind already used successfully in the exterior architectural sector, have not broken through to the swimming pool segment. After the application and drying of these conventional paints with styrene acrylate or straight-acrylate binder, permanent contact with water is often accompanied by blistering, which is an indicator of inadequate adhesion to the typical substrates of a swimming pool. Moreover, the mechanical stability of these paints with conventional binders on permanent water contact is not high enough. On contact with people or cleaning devices, these paints are very easily damaged.

Accordingly there continues to be a need to find a paint coating based on a waterborne binder that on ongoing water contact, as for example in the case of a swimming pool paint, retains effective substrate adhesion and displays good mechanical stability.

To meet this need, the coating materials identified above have been found, as has their use for the coating of areas in permanent water contact, more particularly with swimming pool water.

Composite particles constructed of polymer and finely divided inorganic solid, especially in the form of their aqueous dispersions (aqueous composite-particle dispersions), are common knowledge. They are fluid systems whose disperse phase in the aqueous dispersion medium comprises polymer coils consisting of a plurality of intertwined polymer chains—known as the polymer matrix—and particles composed of finely divided inorganic solid, which are in disperse distribution. Suitable composite particles in accordance with the invention are those having an average particle size of 50 to 350 nm, preferably of 60 to 200 nm.

The average particle size (Z-average) of the inorganic solid and also of the composite particles is determined in the context of this specification, generally, by the method of quasielastic light scattering (DIN-ISO 13321), using, for example, a High Performance Particle Sizer (HPPS) from Malvern Instruments Ltd.

The composite particles that are suitable in accordance with the invention are constructed from inorganic solid having an average particle size of 5 to 100 nm.

Suitable inorganic solids are in principle metals, metal compounds, such as metal oxides and metal salts, and also semimetal compounds and nonmetal compounds. Finely divided metal powders which can be used are noble metal colloids, such as palladium, silver, ruthenium, platinum, gold, and rhodium, for example, and their alloys. Examples that may be mentioned of finely divided metal oxides include titanium dioxide (commercially available, for example, as Hombitec® grades from Sachtleben Chemie GmbH), zirconium(IV) oxide, tin(II) oxide, tin(IV) oxide (commercially available, for example, as Nyacol® SN grades from Nyacol Nano Technologies Inc.), aluminum oxide (commercially available, for example, as Nyacol® AL grades from Nyacol Nano Technologies Inc.), barium oxide, magnesium oxide, various iron oxides, such as iron(II) oxide (wuestite), iron(III) oxide (hematite) and iron(II/III) oxide (magnetite), chromium(III) oxide, antimony(III) oxide, bismuth(III) oxide, zinc oxide (commercially available, for example, as Sachtotec® grades from Sachtleben Chemie GmbH), nickel(II) oxide, nickel(III) oxide, cobalt(II) oxide, cobalt(Ill) oxide, copper(II) oxide, yttrium(III) oxide (commercially available, for example, as Nyacol® YTTRIA grades from Nyacol Nano Technologies Inc.), cerium(IV) oxide (commercially available, for example, as Nyacol® CEO2 grades from Nyacol Nano Technologies Inc.), amorphous and/or in their different crystal modifications, and also their hydroxy oxides, such as, for example, hydroxytitanium(IV) oxide, hydroxyzirconium(IV) oxide, hydroxyaluminum oxide (commercially available, for example, as Disperal® grades from Sasol Germany GmbH) and hydroxyiron(III) oxide, amorphous and/or in their different crystal modifications. The following metal salts, amorphous and/or in their different crystal structures, can be used in principle in the process of the invention: sulfides, such as iron(II) sulfide, iron(II) sulfide, iron(II) disulfide (pyrite), tin(II) sulfide, tin(IV) sulfide, mercury(II) sulfide, cadmium(II) sulfide, zinc sulfide, copper(II) sulfide, silver sulfide, nickel(II) sulfide, cobalt(II) sulfide, cobalt(III) sulfide, manganese(II) sulfide, chromium(III) sulfide, titanium(II) sulfide, titanium(III) sulfide, titanium(IV) sulfide, zirconium(IV) sulfide, antimony(III) sulfide, and bismuth(III) sulfide, hydroxides, such as tin(II) hydroxide, aluminum hydroxide, magnesium hydroxide, calcium hydroxide, barium hydroxide, zinc hydroxide, iron(II) hydroxide, and iron(III) hydroxide, sulfates, such as calcium sulfate, strontium sulfate, barium sulfate, and lead(IV) sulfate, carbonates, such as lithium carbonate, magnesium carbonate, calcium carbonate, zinc carbonate, zirconium(IV) carbonate, iron(II) carbonate, and iron(III) carbonate, orthophosphates, such as lithium orthophosphate, calcium orthophosphate, zinc orthophosphate, magnesium orthophosphate, aluminum orthophosphate, tin(III) orthophosphate, iron(II) orthophosphate, and iron(III) orthophosphate, metaphosphates, such as lithium metaphosphate, calcium metaphosphate, and aluminum metaphosphate, pyrophosphates, such as magnesium pyrophosphate, calcium pyrophosphate, zinc pyrophosphate, iron(III) pyrophosphate, and tin(II) pyrophosphate, ammonium phosphates, such as magnesium ammonium phosphate, zinc ammonium phosphate, hydroxylapatite [Ca₅{(PO4)30H}], orthosilicates, such as lithium orthosilicate, calcium/magnesium orthosilicate, aluminum orthosilicate, iron(II) orthosilicate, iron(III) orthosilicate, magnesium orthosilicate, zinc orthosilicate, zirconium(III) orthosilicate and zirconium(IV) orthosilicate, metasilicates, such as lithium metasilicate, calcium/magnesium metasilicate, calcium metasilicate, magnesium metasilicate, and zinc metasilicate, phyllosilicates, such as sodium aluminum silicate and sodium magnesium silicate, especially in spontaneously delaminating form, such as, for example, Optigel® SH and Optigel® EX 0482 (trademarks of Südchemie AG), Saponit® SKS-20 and Hektorit® SKS 21 (trademarks of Hoechst AG), and Laponite® RD and Laponite® GS (trademarks of Rockwood Holdings, Inc.), aluminates, such as lithium aluminate, calcium aluminate, and zinc aluminate, borates, such as magnesium metaborate and magnesium orthoborate, oxalates, such as calcium oxalate, zirconium(IV) oxalate, magnesium oxalate, zinc oxalate, and aluminum oxalate, tartrates, such as calcium tartrate, acetylacetonates, such as aluminum acetyl-acetonate and iron(III) acetylacetonate, salicylates, such as aluminum salicylate, citrates, such as calcium citrate, iron(II) citrate, and zinc citrate, palmitates, such as aluminum palmitate, calcium palmitate, and magnesium palmitate, stearates, such as aluminum stearate, calcium stearate, magnesium stearate, and zinc stearate, laurates, such as calcium laurate, linoleates, such as calcium linoleate, and oleates, such as calcium oleate, iron(II) oleate or zinc oleate.

As an essential semimetal compound which can be used in accordance with the invention, mention may be made of amorphous silicon dioxide and/or silicon dioxide present in different crystal structures. Silicon dioxide suitable in accordance with the invention is commercially available and can be obtained, for example, as Aerosil® (trademark of Evonik AG), Nalco® (trademark of Nalco), Levasil® (trademark of H. C. Stark GmbH), Ludox® (trademark of DuPont), Nyacol® and Bindzil® (trademarks of Akzo-Nobel), and Snowtex® (trademark of Nissan Chemical Industries, Ltd.). Nonmetal compounds suitable in accordance with the invention are, for example, colloidal graphite or diamond.

Particularly suitable finely divided inorganic solids are those whose solubility in water at 20° C. and atmospheric pressure (1 atm=1.013 bar absolute) is ≦1 g/l, preferably ≦0.1 g/l and, in particular, ≦0.01 g/l. Particular preference is given to compounds selected from the group consisting of silicon dioxide, aluminum oxide, tin(IV) oxide, yttrium(III) oxide, cerium(IV) oxide, hydroxyaluminum oxide, calcium carbonate, magnesium carbonate, calcium orthophosphate, magnesium orthophosphate, calcium metaphosphate, magnesium metaphosphate, calcium pyrophosphate, magnesium pyrophosphate, orthosilicates, such as lithium orthosilicate, calcium/magnesium orthosilicate, aluminum orthosilicate, iron(II) orthosilicate, iron(III) orthosilicate, magnesium orthosilicate, zinc orthosilicate, zirconium(III) orthosilicate, and zirconium(IV) orthosilicate, metasilicates, such as lithium metasilicate, calcium/magnesium metasilicate, calcium metasilicate, magnesium metasilicate, and zinc metasilicate, phyllosilicates, such as sodium aluminum silicate and sodium magnesium silicate, especially in spontaneously delaminating form, such as, for example, products from the series including Nanofil®, Optigel®, Cloisite° (trademarks of Südchemie AG), Somasif®, Lucentite° (trademarks of CBC Japan Co., Ltd), Saponit®, Hektorit® (trademarks of Hoechst AG) and Laponite® (trademark of Rockwood Holdings, Inc.), or iron(II) oxide, iron(III) oxide, iron(II/III) oxide, titanium dioxide, hydroxylapatite, zinc oxide, and zinc sulfide.

Preferably the at least one finely divided inorganic solid is selected from the group consisting of silicon dioxide, phyllosilicates, aluminum oxide, hydroxyaluminum oxide, calcium carbonate, magnesium carbonate, calcium orthophosphate, magnesium orthophosphate, iron(II) oxide, iron(III) oxide, iron(II/III) oxide, tin(IV) oxide, cerium(IV) oxide, yttrium(III) oxide, titanium dioxide, hydroxylapatite, zinc oxide, and zinc sulfide.

Particular preference is given to silicon compounds, such as pyrogenic (fumed) silica, colloidal silica (silicon dioxide), and/or phyllosilicates.

In the processes of the invention it is also possible to use with advantage the commercially available compounds of the Aerosil®, Levasil®, Ludox®, Nyacol®, Nalco®, and Bindzil® grades (silicon dioxide), Nanofil®, Optigel®, Somasif®, Cloisite®, Lucentite®, Saponit®, Hektorit®, and Laponite® grades (phyllosilicates), Disperal° grades (hydroxyaluminum oxide), Nyacol® AL grades (aluminum oxide), Hombitec® grades (titanium dioxide), Nyacol® SN grades (tin(IV) oxide), Nyacol® YTTRIA grades (yttrium(III) oxide), Nyacol® CEO2 grades (cerium(IV) oxide), and Sachtotec® grades (zinc oxide).

The finely divided inorganic solids which can be used to prepare the composite particles have particles which, dispersed in the aqueous polymerization medium, have a particle diameter of ≦100 nm. Finely divided inorganic solids used successfully are those whose dispersed particles have a particle diameter ≧5 nm but ≦90 nm, ≦80 nm, ≦70 nm, ≦60 nm, ≦50 nm, ≦40 nm, ≦30 nm, ≦20 nm or ≦10 nm and all values in between. With advantage, finely divided inorganic solids are used which have a particle diameter ≦50 nm.

The composite particles that are suitable in accordance with the invention have a polymer matrix having a T₉ in the range from −60 to +40° C. The glass transition temperature, T_{g}, here means the midpoint temperature as determined in accordance with ASTM D 3418-82 by differential scanning calorimetry (DSC) (cf. Ullmann's Encyclopedia of Industrial Chemistry, 5th Edition, Volume A 21, VCH Weinheim 1992, p. 169 and also Zosel, Farbe and Lack 82 (1976), pp. 125-134; see also DIN 53765).

Generally speaking, the polymer matrix is a copolymer obtained by copolymerizing two or more monomers M. For the skilled worker it is possible to use skilful selection of the monomer composition to prepare polymers having a glass transition temperature in the range from −60 to +20° C.

According to Fox (see Ullmanns Enzyklopädie der technischen Chemie, 4th edition, volume 19, Weinheim (1980), pp. 17, 18) it is possible to estimate the glass transition temperature T_{g}. The glass transition temperature of copolymers with low levels of or no crosslinking is given at high molar masses in good approximation by:

$$\frac{1}{Tg} = \frac{{X}^{1}}{{Tg}^{1}} + \frac{{X}^{2}}{{Tg}^{2}} + … \frac{{X}^{n}}{{Tg}^{n}}$$

where X¹, X², . . . , Xn are the mass fractions 1, 2, . . . , n and T_{g}¹, T_{g}², . . . , T_{g}ⁿ are the glass transition temperatures of the polymers synthesized in each case only from one of the monomers 1, 2, . . . , n in degrees Kelvin. The latter are known, for example, from Ullmann's Encyclopedia of Industrial Chemistry, VCH, Weinheim, 5th edition, volume A 21 (1992) p. 169 or from J. Brandrup, E. H. Immergut, Polymer Handbook 3rd edition, J. Wiley, New York 1989.

The polymer matrix of the composite particles is obtainable by free-radical emulsion polymerization of at least one ethylenically unsaturated monomer.

Ethylenically unsaturated monomers contemplated include all those which can be free-radically polymerized easily in an aqueous medium and which are familiar to the skilled worker in accordance with the method of aqueous emulsion polymerization. Generally speaking, the monomers M are selected from esters of α,β-ethylenically unsaturated monocarboxylic and dicarboxylic acids with C₁-C₂₀ alkanols, vinylaromatics, esters of vinyl alcohol with C₁-C₁₈ monocarboxylic acids, ethylenically unsaturated nitriles, C₂-C₈ monoolefins, nonaromatic hydrocarbons having at least two conjugated double bonds, ethylenically unsaturated monomers having at least one acid group, and ethylenically unsaturated monomers having at least one amino, amido, ureido or N-heterocyclic group, and/or their alkylated ammonium derivatives protonated on the nitrogen, or ethylenically unsaturated monomers which contain at least one silicon-containing functional group (silane monomers).

Examples of suitable monomers M are as follows:
(a): esters of α,β-ethylenically unsaturated monocarboxylic and dicarboxylic acids with C₁-C₂₀ alkanols, more particularly the esters of acrylic acid, methacrylic acid, and of ethacrylic acid, maleic acid, fumaric acid and itaconic acid with alkanols containing generally 1 to 12, preferably 1 to 8 and more particularly 1 to 4 C atoms, such as, in particular, methyl, ethyl, n-butyl, isobutyl and 2-ethylhexyl acrylate and methacrylate, dimethyl maleate or di-n-butyl maleate
(b): vinylaromatics, preferably styrene, such as styrene, α-methylstyrene, o-chloro-styrene or vinyltoluenes
(c): esters of vinyl alcohol with C₁-C₁₈-monocarboxylic acids such as vinyl acetate, vinyl propionate, vinyl n-butyrate, vinyl laurate and vinyl stearate,
(d): ethylenically unsaturated nitriles such as acrylonitrile and methacrylonitrile.
(e): C₂-C₈ monoolefins and nonaromatic hydrocarbons having at least two conjugated double bonds, such as ethylene, propylene, isobutylene, isoprene and butadiene.

The aforementioned monomers M may be used individually, in the form of mixtures within one class of monomer, or in the form of mixtures from different classes of monomer, provided the polymer has a glass transition temperature T_{g} in the range from −60 to +20° C. With particular advantage the composition of the ethylenically unsaturated monomers is selected such that the resulting polymer has a glass transition temperature ≦15° C., with particular preference ≦10° C., and frequently ≧−50° C. and often ≧−40° C. or ≧−30° C.

The monomers M generally include at least 80%, preferably at least 85%, more preferably at least 90%, by weight, based on the total monomer amount, of a monoethylenically unsaturated monomer M1 (principal monomer) having a water solubility<10 g/l at 25° C. and 1 bar in deionized water. These include, more particularly, the monomers of classes (a), (b), (c), and (e). As principal monomers M1, preference is given to monomers of classes (a) and (b).

Further to at least one principal monomer M1, in the free-radical emulsion polymerization for preparing the polymer matrix it is possible to use at least one further monomer M2, these monomers being ethylenically unsaturated and comprising either at least one acid group and/or its corresponding anion, or those ethylenically unsaturated monomers M2 which comprise at least one amino, amido, ureido or

N-heterocyclic group and/or the ammonium derivatives thereof that are alkylated or protonated on the nitrogen. These monomers M2 are generally present to a minor degree (secondary monomers). Based on the total monomer amount, the amount of monomers M2 is ≦10%, often ≧0.1% and ≦7%, and frequently ≧0.2% and ≦5%, by weight.

As ethylenically unsaturated monomers containing at least one acid group, the acid group may, for example, be a carboxylic, sulfonic, sulfuric, phosphoric and/or phosphonic acid group. Examples of such monomers M2 are acrylic acid, methacrylic acid, maleic acid, fumaric acid, itaconic acid, crotonic acid, 4-styrenesulfonic acid, 2-methacryloyloxyethylsulfonic acid, 2-acrylamido-2-methylpropanesulfonic acid, vinylsulfonic acid, and vinylphosphonic acid, and also phosphoric monoesters of n-hydroxyalkyl acrylates and n-hydroxyalkyl methacrylates, such as phosphoric monoesters of hydroxyethyl acrylate, n-hydroxypropyl acrylate, n-hydroxybutyl acrylate and hydroxyethyl methacrylate, n-hydroxypropyl methacrylate or n-hydroxybutyl methacrylate, for example. In accordance with the invention, however, it is also possible to use the ammonium and alkali metal salts of the aforementioned ethylenically unsaturated monomers containing at least one acid group. Particularly preferred alkali metal is sodium or potassium. Examples of such compounds are the ammonium, sodium, and potassium salts of acrylic acid, methacrylic acid, maleic acid, fumaric acid, itaconic acid, crotonic acid, 4-styrenesulfonic acid, 2-methacryloyloxy-ethylsulfonic acid, 2-acrylamido-2-methylpropanesulfonic acid, vinylsulfonic acid, and vinylphosphonic acid, and also the mono- and di-ammonium, -sodium and -potassium salts of the phosphoric monoesters of hydroxyethyl acrylate, n-hydroxypropyl acrylate, n-hydroxybutyl acrylate and hydroxyethyl methacrylate, n-hydroxypropyl methacrylate or n-hydroxybutyl methacrylate.

Preference is given to using acrylic acid, methacrylic acid, maleic acid, fumaric acid, itaconic acid, crotonic acid, 4-styrenesulfonic acid, 2-methacryloyloxyethylsulfonic acid, vinylsulfonic acid, and vinylphosphonic acid as monomers M2.

As monomers M2, use is additionally made of ethylenically unsaturated monomers which comprise at least one amino, amido, ureido or N-heterocyclic group, and/or their ammonium derivatives alkylated or protonated on the nitrogen.

Examples of monomers M2 which comprise at least one amino group are 2-aminoethyl acrylate, 2-aminoethyl methacrylate, 3-aminopropyl acrylate, 3-aminopropyl methacrylate, 4-amino-n-butyl acrylate, 4-amino-n-butyl methacrylate, 2-(N-methyl-amino)ethyl acrylate, 2-(N-methylamino)ethyl methacrylate, 2-(N-ethylamino)ethyl acrylate, 2-(N-ethylamino)ethyl methacrylate, 2-(N-n-propylamino)ethyl acrylate, 2-(N-n-propylamino)ethyl methacrylate, 2-(N-isopropylamino)ethyl acrylate, 2-(N-isopropylamino)ethyl methacrylate, 2-(N-tert-butylamino)ethyl acrylate, 2-(N-tert-butylamino)ethyl methacrylate (available commercially, for example, as Norsocryl® TBAEMA from Arkema Inc.), 2-(N,N-dimethylamino)ethyl acrylate (available commercially, for example, as Norsocryl® ADAME from Arkema Inc.), 2-(N,N-dimethyl-amino)ethyl methacrylate (available commercially, for example, as Norsocryl® MADAME from Arkema Inc.), 2-(N,N-diethylamino)ethyl acrylate, 2-(N,N-diethylamino)-ethyl methacrylate, 2-(N,N-di-n-propylamino)ethyl acrylate, 2-(N,N-di-n-propylamino)-ethyl methacrylate, 2-(N,N-diisopropylamino)ethyl acrylate, 2-(N,N-diisopropyl-amino)ethyl methacrylate, 3-(N-methylamino)propyl acrylate, 3-(N-methylamino)propyl methacrylate, 3-(N-ethylamino)propyl acrylate, 3-(N-ethylamino)propyl methacrylate, 3-(N-n-propylamino)propyl acrylate, 3-(N-n-propylamino)propyl methacrylate, 3-(N-isopropylamino)propyl acrylate, 3-(N-isopropylamino)propyl methacrylate, 3-(N-tert-butylamino)propyl acrylate, 3-(N-tert-butylamino)propyl methacrylate, 3-(N,N-dimethylamino)propyl acrylate, 3-(N,N-dimethylamino)propyl methacrylate, 3-(N,N-diethylamino)propyl acrylate, 3-(N,N-diethylamino)propyl methacrylate, 3-(N,N-di-n-propylamino)propyl acrylate, 3-(N,N-di-n-propylamino)propyl methacrylate, 3-(N,N-diisopropylamino)propyl acrylate, and 3-(N,N-diisopropylamino)propyl methacrylate.

Examples of monomers M2 which comprise at least one amido group are acrylamide, methacrylamide, N-methylacrylamide, N-methylmethacrylamide, N-ethylacrylamide, N-ethylmethacrylamide, N-n-propylacrylamide, N-n-propylmethacrylamide, N-isopropylacrylamide, N-isopropylmethacrylamide, N-tert-butylacrylamide, N-tert-butyl-methacrylamide, N,N-dimethylacrylamide, N,N-dimethylmethacrylamide, N,N-diethyl-acrylamide, N,N-diethylmethacrylamide, N,N-di-n-propylacrylamide, N,N-di-n-propyl-methacrylamide, N,N-diisopropylacrylamide, N,N-diisopropylmethacrylamide, N,N-di-n-butylacrylamide, N,N-di-n-butylmethacrylamide, N-(3-N′,N′-dimethylaminopropyl)-methacrylamide, diacetoneacrylamide, N,N′-methylenebisacrylamide, N-(diphenyl-methyl)acrylamide, N-cyclohexylacrylamide, and also N-vinylpyrrolidone and N-vinyl-caprolactam.

Examples of monomers M2 which comprise at least one ureido group are N,N′-divinyl-ethyleneurea and 2-(1-imidazolin-2-onyl)ethyl methacrylate (available commercially, for example, as Norsocryl® 100 from Arkema Inc.).

Examples of monomers M2 which comprise at least one N-heterocyclic group are 2-vinylpyridine, 4-vinylpyridine, 1-vinylimidazole, 2-vinylimidazole, and N-vinyl-carbazole. Preference is given to using as monomers M2 the following compounds: 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylaminopropyl)methacrylamide, and 2-(1-imidazolin-2-onyl)ethyl methacrylate.

Depending on the pH of the aqueous reaction medium, it is possible for some or all of the aforementioned nitrogen-containing monomers M2 to be present in the N-protonated quaternary ammonium form.

Examples that may be mentioned as monomers M2 which have a quaternary alkylammonium structure on the nitrogen include 2-(N,N,N-trimethylammonium)ethyl acrylate chloride (available commercially, for example, as Norsocryl® ADAMQUAT MC 80 from Arkema Inc.), 2-(N,N,N-trimethylammonium)ethyl methacrylate chloride (available commercially, for example, as Norsocryl® MADQUAT MC 75 from Arkema Inc.), 2-(N-methyl-N,N-diethylammonium)ethyl acrylate chloride, 2-(N-methyl-N,N-diethylammonium)ethyl methacrylate chloride, 2-(N-methyl-N,N-dipropylammonium)-ethyl acrylate chloride, 2-(N-methyl-N,N-dipropylammonium)ethyl methacrylate, 2-(N-benzyl-N,N-dimethylammonium)ethyl acrylate chloride (available commercially, for example, as Norsocryl® ADAMQUAT BZ 80 from Arkema Inc.), 2-(N-benzyl-N,N-dimethylammonium)ethyl methacrylate chloride (available commercially, for example, as Norsocryl® MADQUAT BZ 75 from Elf Atochem), 2-(N-benzyl-N,N-diethyl-ammonium)ethyl acrylate chloride, 2-(N-benzyl-N,N-diethylammonium)ethyl methacrylate chloride, 2-(N-benzyl-N,N-dipropylammonium)ethyl acrylate chloride, 2-(N-benzyl-N,N-dipropylammonium)ethyl methacrylate chloride, 3-(N,N,N-trimethyl-ammonium)propyl acrylate chloride, 3-(N,N,N-trimethylammonium)propyl methacrylate chloride, 3-(N-methyl-N,N-diethylammonium)propyl acrylate chloride, 3-(N-methyl-N,N-diethylammonium)propyl methacrylate chloride, 3-(N-methyl-N,N-dipropylammonium)-propyl acrylate chloride, 3-(N-methyl-N,N-dipropylammonium)propyl methacrylate chloride, 3-(N-benzyl-N,N-dimethylammonium)propyl acrylate chloride, 3-(N-benzyl-N,N-dimethylammonium)propyl methacrylate chloride, 3-(N-benzyl-N,N-diethyl-ammonium)propyl acrylate chloride, 3-(N-benzyl-N,N-diethylammonium)propyl methacrylate chloride, 3-(N-benzyl-N,N-dipropylammonium)propyl acrylate chloride, and 3-(N-benzyl-N,N-dipropylammonium)propyl methacrylate chloride. It is of course also possible to use the corresponding bromides and sulfates instead of the chlorides named.

Preference is given to using 2-(N,N,N-trimethylammonium)ethyl acrylate chloride, 2-(N,N,N-trimethylammonium)ethyl methacrylate chloride, 2-(N-benzyl-N,N-dimethyl-ammonium)ethyl acrylate chloride, and 2-(N-benzyl-N,N-dimethylammonium)ethyl ethacrylate chloride.

Frequently it may be advantageous, in addition to the aforementioned monomers, to use, additionally, ethylenically unsaturated monomers M3 which contain at least one silicon-containing functional group (silane monomers), such as, for example, vinylalkoxysilanes, such as, more particularly, vinyltrimethoxysilane, vinyltriethoxysilane, vinyltriisopropoxysilane, vinyltriphenoxysilane, vinyltris(dimethyl-siloxy)silane, vinyltris(2-methoxyethoxy)silane, vinyltris(3-methoxypropoxy)silane and/or vinyltris(trimethylsiloxy)silane, acryloyloxysilanes, such as more particularly 2-(acryloyloxyethoxy)trimethylsilane, acryloyloxymethyltrimethylsilane, (3-acryloyloxy-propyl)dimethylmethoxysilane, (3-acryloyloxypropyl)methylbis(trimethylsiloxy)silane, (3-acryloyloxypropyl)methyldimethoxysilane, (3-acryloyloxypropyl)trimethoxysilane and/or (3-acryloyloxypropyl)tris(trimethylsiloxy)silane, methacryloyloxysilanes, such as more particularly (3-methacryloyloxypropyl)trimethoxysilane, (3-methacryloyl-oxypropyl)methyldimethoxysilane, (3-methacryloyloxypropyl)dimethylmethoxysilane, (3-methacryloyloxypropyl)triethoxysilane, (methacryloyl-oxymethyl)-methyldiethoxysilane and/or (3-methacryloyloxypropyl)methyldiethyloxysilane. With particular advantage in accordance with the invention use is made of acryloyloxysilanes and/or methacryloyloxysilanes, more particularly methacryloyl-oxysilanes, such as preferably (3-methacryloyloxypropyl)trimethoxysilane, (3-methacryloyloxypropyl)methyldimethoxysilane, (3-methacryloyloxypropyl)-dimethylmethoxysilane, (3-methacryloyloxypropyl)triethoxysilane, (methacryloyloxymethyl)methyldiethoxysilane and/or (3-methacryloyloxypropyl)-methyldiethoxysilane. The amount of silane monomers is ≧0.01% and ≦10%, advantageously ≧0.1% and ≦5%, and with particular advantage ≧0.1% and ≦2%, by weight, based in each case on the total monomer amount.

Furthermore, it is possible to add, to the monomer or monomers, crosslinkers, which customarily increase the internal strength of the films of the polymer matrix. They normally contain at least one epoxy, hydroxyl, N-methylol or carbonyl group or at least two nonconjugated ethylenically unsaturated double bonds. Examples here are monomers having two vinyl radicals, monomers having two vinylidene radicals, and monomers having two alkenyl radicals. Particularly advantageous in this context are the diesters of dihydric alcohols with α,β-monoethylenically unsaturated monocarboxylic acids, among which acrylic and methacrylic acid are preferred. Examples of this kind of monomer having two nonconjugated ethylenically unsaturated double bonds are alkylene glycol diacrylates and dimethacrylates such as ethylene glycol diacrylate, 1,2-propylene glycol diacrylate, 1,3-propylene glycol diacrylate, 1,3-butylene glycol diacrylate, 1,4-butylene glycol diacrylates and ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate, and also glycidyl acrylate, glycidyl methacrylate, divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate, and triallyl isocyanurate. Of particular importance in this context are also the methacrylic and acrylic C₁-C₈ hydroxyalkyl esters, such as n-hydroxyethyl, n-hydroxypropyl or n-hydroxybutyl acrylate and methacrylate, and compounds such as diacetone-acrylamide and acetylacetoxyethyl acrylate and methacrylate, N-(hydroxymethyl)prop-2-enamide and N-(hydroxymethyl)-2-methyl-2-propenamide.

In accordance with the invention, the above-stated crosslinkers are used in amounts ≦5%, frequently ≧0.1% and ≦3%, and often ≧0.5% and ≦2%, by weight, based in each case on the total monomer amount for the polymerization.

The composite particles used in accordance with the invention are constructed of
20% to 60%, preferably 20% to 50%, more particularly 30% to 50%, by weight, based on the composite particle, of inorganic solid having an average particle size of 5 to 100 nm, and
40% to 90%, preferably 50% to 80%, more particularly 50% to 70%, by weight, based on the composite particle, of a polymer matrix having a T_{g} in the range from −60 to +40° C. and obtainable by free-radical emulsion polymerization of one or more ethylenically unsaturated monomers.

Composite particles and processes for preparing them in the form of aqueous composite-particle dispersions, and also their use, are known to the skilled worker and are disclosed in, for example, the specifications U.S. Pat. No. 3,544,500, U.S. Pat. No. 4,421,660, U.S. Pat. No. 4,608,401, U.S. Pat. No. 4,981,882, EP-A 104 498, EP-A 505 230, EP-A 572 128, GB-A 2 227 739, WO 0118081, WO 0129106, and WO 03000760, and also in Long et al., Tianjin Daxue Xuebao 1991, 4, pages 10 to 15, Bourgeat-Lami et al., Die Angewandte Makromolekulare Chemie 1996, 242, pages 105 to 122, Paulke et al., Synthesis Studies of Paramagnetic Polystyrene Latex Particles in Scientific and Clinical Applications of Magnetic Carriers, pages 69 to 76, Plenum Press, New York, 1997, Armes et al., Advanced Materials 1999, 11, No. 5, pages 408 to 410.

These aqueous composite-particle dispersions are prepared advantageously by dispersing ethylenically unsaturated monomers in an aqueous medium and subjecting them to polymerization, by the method of free-radically aqueous emulsion polymerization, by means of at least one free-radical polymerization initiator in the presence of at least one dispersed, finely divided inorganic solid and at least one dispersant.

In accordance with the invention it is possible to use any aqueous composite-particle dispersions—including, for example, those obtainable by the prior art cited above—prepared using a monomer mixture comprising epoxide monomers to an extent >0 and <10% by weight, preferably 0.1% to 5% by weight, and with particular preference 0.5% to 3% by weight.

In accordance with the invention it is possible with advantage to use those aqueous composite-particle dispersions prepared using the monomer mixture comprising epoxide monomers in accordance with the procedure described in WO 03000760.

Additionally it is possible with advantage to use composite-particle dispersions prepared by the process of European patent application 09157984.7, unpublished at the priority date of the present specification. That process is characterized in that the composite particle is constructed by free-radical emulsion polymerization, in which ethylenically unsaturated monomers are dispersed in an aqueous medium and polymerized by means of 0.05% to 2% by weight of at least one free-radical polymerization initiator in the presence of 1% to 1000% by weight of at least one dispersed, finely divided inorganic solid, based in each case on the total monomer amount, and of at least one dispersing assistant, by
a) including at least a portion of the inorganic solid in an initial charge in an aqueous polymerization medium, in the form of an aqueous dispersion of solids, and subsequently metering in 0.01% to 20% by weight of the total monomer amount and at least 60% by weight of the total amount of free-radical polymerization initiator, and polymerizing the added monomers under polymerization conditions to a monomer conversion ≧80% by weight (polymerization stage 1), and subsequently
b) metering any remainder of the inorganic solid, any remainder of the free-radical polymerization initiator, and the remainder of the monomers into the polymerization mixture of stage 1 under polymerization conditions and continuing polymerization to a monomer conversion ≧90% by weight (polymerization stage 2).

According to this preferred process variant, clear water, such as clear drinking water, for example, but very advantageously deionized water, is used, its total amount being calculated such that it is ≧30% and ≦99% and advantageously ≧35% and ≦95% and more advantageously ≧40% and ≦90%, by weight, based on the aqueous composite-particle dispersion.

In accordance with this preferred variant, at least a portion of the water is included in the initial charge to the polymerization vessel in step a) of the process, and any remainder is metered in during the polymerization stage 1 or 2.

The inorganic solids may be used either in the form of powders or in the form of stable aqueous dispersions of solids, referred to as sols.

Aqueous dispersions of solids are frequently prepared directly during synthesis of the finely divided inorganic solids in aqueous medium, or alternatively by dispersing the finely divided inorganic solids into the aqueous medium. Depending on the way in which said finely divided inorganic solids are prepared, this is done either directly, as in the case, for example, of precipitated or fumed silicon dioxide, aluminum oxide, etc., or with the aid of appropriate auxiliary assemblies, such as dispersers or ultrasound sonotrodes, for example. In many cases the aqueous dispersions of solids are stable aqueous dispersions of solids.

By stable aqueous dispersions of solids are meant those aqueous dispersions of solids which, for an initial solids concentration of 0.1% by weight, based on the aqueous dispersion of solids, still comprise more than 90% by weight of the originally dispersed solid in dispersed form an hour after their preparation or after homogeneous dispersion of the sedimented finely divided solids, without further energy input (such as stirring or shaking).

The quantitative determination of the initial solids concentration and of the solids concentration after an hour is made, in the context of the present specification, via the method of the analytical ultracentrifuge (in this regard, cf. S. E. Harding et al., Analytical Ultracentrifugation in Biochemistry and Polymer Science, Royal Society of Chemistry, Cambridge, Great Britain 1992, Chapter 10, Analysis of Polymer Dispersions with an Eight-Cell-AUC-Multiplexer: High Resolution Particle Size Distribution and Density Gradient Techniques, W. Mächtle, pages 147 to 175).

In accordance with the preferred preparation variant, 1% to 1000%, advantageously 1% to 100%, and with particular advantage 2% to 70% by weight of the inorganic solid is used, based on the total monomer amount.

The preferred process takes place such that in step a) of the process at least a portion, often ≧10%, ≧20%, ≧30% or ≧40% by weight and advantageously ≧50%, ≧60%, ≧70%, ≧80% or ≧90% by weight of the total amount of the inorganic solid is included in the initial charge in the aqueous polymerization medium, to form an aqueous dispersion of solids. Any remainder of inorganic solid is metered into the aqueous polymerization medium in step b) of the process, under polymerization conditions, discontinuously in one or more portions or continuously at constant or varying flow rates, particularly in the form of an aqueous dispersion of solids. With advantage, however, in step a) of the process, the total amount of the inorganic solid is included in the initial charge in process step a) in the aqueous polymerization medium, in the form of an aqueous dispersion of solids. Where the inorganic solid is used in powder form, it can be advantageous to disperse the finely divided solids powder with the aid of suitable auxiliary assemblies, such as stirrers, dispersers or ultrasound sonotrodes, for example, in the aqueous polymerization medium.

In the course of preparing the aqueous composite-particle dispersions it is common to make additional use of dispersing assistants, which maintain not only the finely divided inorganic particulate solids but also the monomer droplets and the resultant composite particles in disperse distribution in the aqueous polymerization medium and thus ensure the stability of the aqueous composite-particle dispersions produced. Dispersing assistants include not only the protective colloids that are typically used for implementing free-radical aqueous emulsion polymerizations, but also emulsifiers.

A comprehensive description of suitable protective colloids is found in Houben-Weyl, Methoden der organischen Chemie, volume XIV/1, Makromolekulare Stoffe, Georg-Thieme-Verlag, Stuttgart, 1961, pages 411 to 420.

Suitable neutral, anionic or cationic protective colloids are described in WO 03/000760 at page 13, the disclosure content of which is hereby explicitly incorporated by reference.

It will be appreciated that mixtures of emulsifiers and/or protective colloids can also be used. As dispersing assistants it is common to use exclusively emulsifiers, which, unlike the protective colloids, have relative molecular weights of typically below 1500 g/mol. Where mixtures of surface-active substances are used, the individual components must of course be compatible with one another, something which in case of doubt can be checked by means of a few preliminary tests. An overview of suitable emulsifiers is found in Houben-Weyl, Methoden der organischen Chemie, volume XIV/1, Makromolekulare Stoffe, Georg-Thieme-Verlag, Stuttgart, 1961, pages 192 to 208.

Common nonionic, anionic, and cationic emulsifiers are described in WO 03/000760 at pages 13-15, the disclosure content of which is hereby expressly incorporated by reference.

Frequently for preparing the aqueous composite-particle dispersions the amount of dispersing assistant used is ≧0.1% and23 10%, often ≧0.25% and ≦7.0%, and frequently ≧0.5% and ≦5.0%, by weight, based in each case on the total monomer amount.

It is preferred to use emulsifiers, more particularly nonionic and/or anionic emulsifiers. Particular advantage attaches to using anionic emulsifiers.

In accordance with one preferred process variant it is possible if desired to include a portion or the total amount of dispersing assistant in the initial charge in the polymerization vessel, as a constituent of the aqueous polymerization medium comprising a portion or the total amount of the inorganic solid [step a) of the process]. It is, however, also possible to supply the total amount or any remainder of dispersing assistant to the aqueous polymerization medium in the course of step a) and/or b) of the process. In that case the total amount or any remainder of dispersing assistant can be metered into the aqueous polymerization medium discontinuously in one or more portions or continuously at constant or varying flow rates. With particular advantage, at least a portion of dispersing assistant is included in the initial charge in step a) of the process. Where the ethylenically unsaturated monomers are metered in in the form of an aqueous monomer emulsion in process step a) and/or b), portions of dispersing assistant are used during process step c) and/or d), particularly as a constituent of an aqueous monomer emulsion.

In step a) of the process, advantageously ≧1% and ≦15% by weight and with particular advantage ≧5% and ≦15% by weight of the total monomer amount is metered in.

All of the aforementioned ethylenically unsaturated monomers may be metered as separate individual streams or in a mixture, discontinuously in one or more portions or continuously at constant or varying flow rates, in process stages a) and/or b). The ethylenically unsaturated monomers may be added as they are, in the form of a solvent-free or solvent-containing monomer mixture, or, advantageously, in the form of an aqueous monomer emulsion. It will be appreciated that the process of the invention also encompasses the wide variety of monomer feed procedures that are familiar to the skilled worker, such as core/shell or gradient procedures, for example.

Free-radical polymerization initiators suitable for triggering the free-radical polymerization include all those initiators (free-radical initiators) which are capable of triggering a free-radical aqueous emulsion polymerization. The initiators can in principle comprise both peroxides and azo compounds. Redox initiator systems are also suitable, of course. Peroxides used can in principle be inorganic peroxides, such as hydrogen peroxide or peroxodisulfates, such as the mono- or di-alkali metal salts or ammonium salts of peroxodisulfuric acid, examples being the mono- and di-sodium and -potassium salts, or ammonium salts, thereof, or else organic peroxides, such as alkyl hydroperoxides, examples being tert-butyl, p-menthyl and cumyl hydroperoxide, and also dialkyl or diaryl peroxides, such as di-tert-butyl peroxide or dicumyl peroxide. Azo compounds used are essentially 2,2′-azobis(isobutyronitrile), 2,2′-azobis(2,4-dimethylvaleronitrile), and 2,2′-azobis(amidinopropyl) dihydrochloride (AIBA, corresponding to V-50 from Wako Chemicals). Suitable oxidizing agents for redox initiator systems are essentially the abovementioned peroxides. Corresponding reducing agents used can be compounds of sulfur with a low oxidation state, such as alkali metal sulfites, e.g., potassium and/or sodium sulfite, alkali metal hydrogen sulfites, e.g., potassium and/or sodium hydrogen sulfite, alkali metal metabisulfites, e.g., potassium and/or sodium metabisulfite, formaldehyde-sulfoxylates, e.g., potassium and/or sodium formaldehyde-sulfoxylate, alkali metal salts, especially potassium salts and/or sodium salts, of aliphatic sulfinic acids, and alkali metal hydrogen sulfides, e.g., potassium and/or sodium hydrogen sulfide, salts of polyvalent metals, such as iron(II) sulfate, iron(II) ammonium sulfate, iron(II) phosphate, enediols, such as dihydroxymaleic acid, benzoin and/or ascorbic acid, and reducing saccharides, such as sorbose, glucose, fructose and/or dihydroxyacetone. Where redox initiator systems are used in accordance with the invention, the oxidizing agents and the reducing agents are frequently metered in parallel or, preferably, the total amount of the oxidizing agent in question is introduced initially, and only the reducing agent is metered in. The total amount of free-radical initiator is formed, in the case of redox initiator systems, from the total amounts of oxidizing and reducing agents. Preferred free-radical initiators used, however, are organic and inorganic peroxides, and especially inorganic peroxides, frequently in the form of aqueous solutions. Especially preferred as free-radical initiator are sodium peroxodisulfate, potassium peroxo-disulfate, ammonium peroxodisulfate, hydrogen peroxide and/or tert-butyl hydroperoxide.

In accordance with the invention the amount of free-radical initiator used in total is 0.05% to 2% by weight, advantageously 0.1% to 1.5% by weight, and with particular advantage 0.3% to 1.0% by weight, based in each case on the total monomer amount.

It is essential to the invention that the aqueous dispersion of solids in process stage a) is supplied with a metered feed totaling ≧0.01% and ≦20% by weight of the total monomer amount and ≧60%, preferably ≧70%, and also ≦90% or ≦100%, and with particular preference ≧75% and ≦85%, by weight, of the total amount of free-radical polymerization initiator, and the ethylenically unsaturated monomers metered in are polymerized under polymerization conditions through to a monomer conversion ≧80%, preferably ≧85%, more preferably ≧90%, by weight.

The free-radical initiator may be added to the aqueous polymerization medium in process stage a) under polymerization conditions. An alternative possibility is to add a portion or the total amount of the free-radical initiator to the aqueous polymerization medium, comprising the monomers introduced initially, under conditions not apt to trigger a polymerization reaction, such as at low temperature, for example, and then to bring about polymerization conditions in the aqueous polymerization mixture.

In process stage a) the free-radical initiator or components thereof may be added discontinuously in one or more portions or continuously at constant or varying flow rates.

Determining the degree of monomer conversion is familiar in principle to the skilled worker and is accomplished, for example, by reaction calorimetry.

When in step a) of the process the amount of the monomers used have been polymerized to a conversion 80% by weight (polymerization stage 1), any remainder, i.e., ≦90%, ≦80%, ≦70%, ≦60% and advantageously ≦50%, ≦40%, ≦30%, ≦20% or ≦10%, by weight, of the inorganic solid, any remainder, i.e., ≦40%, ≦30% or, preferably, ≧15% and ≦25% by weight of the free-radical polymerization initiator, and the remainder, i.e., ≧80% and ≦99.99%, preferably ≧85% and ≦99%, and more preferably ≧85% and ≦95%, by weight, of the ethylenically unsaturated monomers are metered in under polymerization conditions in the subsequent step b) of the process and are polymerized through to a monomer conversion ≧90% by weight (polymerization stage 2). In step b) of the process as well, the metered addition of the respective components may take place in the form of separate, individual streams or in a mixture, discontinuously in one or more portions or continuously at constant or varying flow rates. It is of course also possible for the free-radical initiators or ethylenically unsaturated monomers in steps a) and b) of the process to differ.

By polymerization conditions here are meant, in the context of this specification, generally, those temperatures and pressures under which the free-radically initiated aqueous emulsion polymerization proceeds with a sufficient polymerization rate. They are dependent more particularly on the free-radical initiator that is used. Advantageously, the nature and amount of the free-radical initiator, the polymerization temperature, and the polymerization pressure in steps a) and b) of the process are selected such that the free-radical initiator used has a sufficient half-life, while always providing initiating free radicals sufficient to trigger and maintain the polymerization reaction.

Suitable reaction temperatures for the free-radical aqueous emulsion polymerization in steps a) and b) of the process, in the presence of the finely divided inorganic solid, span the entire range from 0 to 170° C. Generally speaking, the temperatures employed are from 50 to 120° C., frequently 60 to 110° C., and often 70 to 100° C. The free-radical aqueous emulsion polymerization of the invention can be conducted at a pressure less than, equal to or greater than atmospheric pressure, and hence the polymerization temperature may exceed 100° C. and may be up to 170° C. Polymerization is carried out preferably in the presence of volatile monomers B, examples being ethylene, butadiene or vinyl chloride, under increased pressure. In this case the pressure may adopt values of 1.2, 1.5, 2, 5, 10 or 15 bar or even higher. Where emulsion polymerizations are conducted under subatmospheric pressure, pressures of 950 mbar, frequently of 900 mbar and often 850 mbar (absolute) are established. The free-radical aqueous emulsion polymerization is advantageously conducted at atmospheric pressure (in the laboratory, for example) or superatmospheric pressure (on the industrial scale, for example) in the absence of oxygen, more particularly under an inert gas atmosphere, such as under nitrogen or argon, for example.

In principle, it is possible to add readily water-soluble organic solvents to the aqueous polymerization medium to a subordinate extent, examples of such solvents being methanol, ethanol, isopropanol, butanols, and also acetone, etc. It is important, however, that the amount of organic solvent added is calculated such that at the end of step b) of the process it is ≦10%, advantageously ≦5%, and with particular advantage ≦2%, by weight, based in each case on the total amount of water in the aqueous composite-particle dispersion obtainable in accordance with the invention. With advantage, in accordance with the invention, no such solvents are added.

Besides the abovementioned components it is also possible, optionally, in the preferred process for preparing the aqueous composite-particle dispersion, to use free-radical chain transfer compounds in order to reduce or control the molecular weights of the polymers obtainable by the polymerization. Suitable compounds of this type include, essentially, aliphatic and/or araliphatic halogen compounds, such as n-butyl chloride, n-butyl bromide, n-butyl iodide, methylene chloride, ethylene dichloride, chloroform, bromoform, bromotrichloromethane, dibromodichloromethane, carbon tetrachloride, carbon tetrabromide, benzyl chloride, benzyl bromide, organic thio compounds, such as primary, secondary or tertiary aliphatic thiols, such as ethanethiol, n-propanethiol, 2-propanethiol, n-butanethiol, 2-butanethiol, 2-methyl-2-propanethiol, n-pentanethiol, 2-pentanethiol, 3-pentanethiol, 2-methyl-2-butanethiol, 3-methyl-2-butanethiol, n-hexanethiol, 2-hexanethiol, 3-hexanethiol, 2-methyl-2-pentanethiol, 3-methyl-2-pentanethiol, 4-methyl-2-pentanethiol, 2-methyl-3-pentanethiol, 3-methyl-3-pentanethiol, 2-ethylbutanethiol, 2-ethyl-2-butanethiol, n-heptanethiol and its isomers, n-octanethiol and its isomers, n-nonanethiol and its isomers, n-decanethiol and its isomers, n-undecanethiol and its isomers, n-dodecanethiol and its isomers, n-tridecanethiol and its isomers, substituted thiols, such as 2-hydroxyethanethiol, aromatic thiols, such as benzenethiol, ortho-, meta-, or para-methylbenzenethiol, and also all other sulfur compounds described in Polymer Handbook 3^{rd} edition, 1989, J. Brandrup and E. H. Immergut, John Wiley & Sons, Section II, pages 133 to 141, and also aliphatic and/or aromatic aldehydes, such as acetaldehyde, propionaldehyde and/or benzaldehyde, unsaturated fatty acids, such as oleic acid, dienes with nonconjugated double bonds, such as divinylmethane, or vinylcyclohexane or hydrocarbons having readily abstractable hydrogen atoms, such as toluene, for example. It is, however, also possible to use mixtures of mutually compatible, abovementioned free-radical chain transfer compounds. The total amount of the free-radical chain transfer compounds used optionally, based on the total monomer amount, is generally ≦5% by weight, often ≦3% by weight, and frequently ≦1% by weight.

Depending on the stability of the aqueous dispersions of solids that are used, steps a) and b) of the process may be carried out in the acidic, neutral or basic pH range. When phyllosilicates are used, the pH is advantageously ≧5 and ≦11, with particular advantage ≧6 and ≦10 (respective sample measured at room temperature and atmospheric pressure). Setting the pH ranges is familiar to the skilled worker and is accomplished more particularly using nonoxidizing inorganic acids, such as hydrochloric, sulfuric or phosphoric acid, or inorganic bases, such as ammonia, sodium hydroxide or potassium hydroxide.

It will be appreciated that the aqueous composite-particle dispersions obtainable by the preferred process may also comprise customary amounts of other, optional auxiliaries familiar to the skilled worker, such as, for example, those known as thickeners, defoamers, buffer substances, preservatives, etc.

Where silane monomers are used in accordance with the preferred process, a preferred embodiment involves metering into the aqueous dispersion of solids, introduced in step a) of the process, in step a) of the process first only ≧5% and ≦70%, advantageously ≧10% and ≦50%, by weight of the total amount of the silane monomers, over a period ≧5 and ≦240 minutes, advantageously ≧30 and ≧120 minutes, and with particular advantage ≧45 and ≦90 minutes, at a temperature ≧20° C., with advantage at a temperature ≧50 and ≦100° C., and with particular advantage at a temperature ≧65 and ≦95° C., and only subsequently metering in any remaining, other ethylenically unsaturated monomers and the free-radical polymerization initiator, under polymerization conditions. The remainder of silane monomers is metered in subsequently in step b) of the process, together with the other ethylenically unsaturated monomers, under polymerization conditions. The total amount of silane monomers in this preferred embodiment is ≧0.1% and ≦2% by weight, based on the total monomer amount.

The aqueous composite-particle dispersions obtainable in this way typically have a total solids content ≧1% and ≦70%, frequently ≧5% and ≦65%, and often ≧10% and ≦60%, by weight.

The composite particles obtainable in this way may have different structures. These composite particles may comprise one or more of the finely divided inorganic particulate solids. The finely divided inorganic particulate solids may be completely enveloped by the polymer matrix. An alternative option is for some of the finely divided inorganic particulate solids to be enveloped by the polymer matrix, while some others are disposed on the surface of the polymer matrix. As will be appreciated, it is also possible for a major fraction of the finely divided inorganic particulate solids to be bound on the surface of the polymer matrix.

Additionally, the remaining amounts of unreacted ethylenically unsaturated monomers or other volatile compounds remaining in the aqueous polymerization medium after the conclusion of the polymerization reaction may be removed by steam stripping and/or inert-gas stripping and/or by means of chemical removal of residual monomers, as described in, for example, specifications DE-A 4419518, EP-A 767180 or DE-A 3834734, without disadvantageously altering the properties of the aqueous composite-particle dispersions.

The aqueous composite-particle dispersions formed by the preferred process are stable and have a low coagulum content, generally 0.5%, preferably 5_{—} 0.1%, and more preferably ≦0.05%, by weight, based in each case on the aqueous composite-particle dispersion.

Another preferred process forms composite-particle dispersions which are obtained by mixing colloidal silicon dioxide with an aqueous polymer dispersion P obtained by free-radical emulsion polymerization of
A) ≧40% by weight of one or more monomers M4 selected from esters of α,β-unsaturated carboxylic acids, vinyl esters of saturated carboxylic acids, and vinylaromatic monomers,
B) 0.1% to 10% by weight of one or more monomers M5 selected from α,β-ethylenically unsaturated monocarboxylic acids, α,β-ethylenically unsaturated dicarboxylic acids, α,β-ethylenically unsaturated sulfonic acids, α,β-ethylenically unsaturated phosphoric acids, and α,β-ethylenically unsaturated phosphonic acids,
   C) 0.5% to 15% by weight of one or more ethylenically unsaturated monomers M6 which contain at least one alkoxysilyl group,
   D) 0.1% to 10% by weight of an ethylenically unsaturated, surface-active monomer M7 comprising at least one anionic and/or nonionic emulsifying group, and
   E) if desired, up to 20% by weight of other monomers, M8, which are copolymerizable with the monomers of groups M4, M5, M6, and M7, based in each case on the total monomer amount, with the proviso that in lieu of or in addition to the copolymerization of the monomer M6, after the emulsion polymerization, 0.5% to 15% by weight, based on the total monomer amount, of a monomer is added which in addition to at least one alkoxysilyl group contains at least one amino, mercapto or epoxide group.

Processes for preparing a composite-particle dispersion of this kind are described in DE 10 2006 046 860 for example, the disclosure content of which is hereby expressly incorporated by reference.

Carrying out an emulsion polymerization by these methods results in the preparation of a polymer dispersion P whose polymer particles comprise a carboxyl group, an alkoxysilyl group, and an emulsifying group and are present in dispersion in water. The monomer combinations employed are selected as described above, so as to obtain the glass transition temperature that is desired for the envisaged application.

Preferred monomers M4 are the monomers recited above under (a).

Additionally to or instead of these it is possible to use hydroxyl-group-containing or epoxide-group-containing (meth)acrylic acid alkyl esters. Where a hydroxyl-group-containing and/or an epoxide-group-containing (meth)acrylic acid alkyl ester is employed, the plastics dispersion prepared therewith additionally comprises, further to the carboxyl and alkoxysilyl groups, a hydroxyl group and/or an epoxide group.

The examples of hydroxyl-group-containing (meth)acrylic acid alkyl esters include hydroxymethyl methacrylate, hydroxyethyl acrylate, hydroxypropyl methacrylate, hydroxypropyl acrylate, hydroxybutyl methacrylate, and hydroxybutyl acrylate. These alkyl esters may be used alone or in the form of a combination of two or more esters.

The examples of epoxide-group-containing (meth)acrylic acid alkyl esters include glycidyl methacrylate or glycidyl acrylate.

Furthermore, in addition to or instead of the methacrylates (a) as principal monomers it is possible to select monomers of abovementioned classes (b) and/or (c).

Further to at least one principal monomer M4 it is possible to use monomers M5 for preparing the polymer dispersion P. The monomers M5 correspond to the abovementioned monomers M2, using ethylenically unsaturated monomers having at least one acid group, such as carboxylic acids, sulfonic acids, phosphoric acids or phosphonic acids, or mixtures thereof.

Further to at least one principal monomer M4, the polymer dispersion P may be prepared using monomers M6 or mixtures thereof. The monomers M6 correspond to the abovementioned silane monomers M3.

Instead of monomers of group M6 or in addition to monomers M6 it is possible to admix the copolymer, following the emulsion polymerization, with a monomer which in addition to at least one alkoxysilyl group contains at least one amino, mercapto or epoxide group, as indicated in DE 10 2006 046 860, paragraphs [0067] to [0079], hereby expressly incorporated by reference.

Besides the principal monomers M4 and the group M5 monomers which carry at least one acid group, and the monomers M6, the plastics dispersion is prepared using monomers M8, which are ethylenically unsaturated, surface-active monomers which comprise at least one anionic and/or nonionic emulsifying group. These emulsifiers are surfactants, and are incorporated into the copolymer during the emulsion polymerization.

The monomers M7 contain at least one hydrophilic group, it being possible for the hydrophilic group to be nonionic, as in the case of a polyglycol group, for example, or to be anionic, as in the case of a sulfate or sulfonate group, for example. The monomers of group D) preferably further contain at least one hydrophobic group, it being possible for the hydrophobic group to be an alkyl, cycloalkyl, alkenyl, aryl or acyl group, for example.

The monomers M8 preferably contain an ethylenically unsaturated group. This is more particularly a vinyl group, an allyl group or the radical of an ethylenically unsaturated acid, such as an acrylic, methacrylic, itaconic or maleic acid radical.

The monomers of group D) preferably contain one to three nonionic or, more particularly, anionic emulsifying groups. Emulsifying groups contemplated include, with particular preference, polyalkylene glycol groups, these groups being, more particularly, anionically functionalized, as for example with a sulfate or sulfonic acid group.

Particularly preferred monomers are indicated in paragraphs [0085] and [0086] of DE 10 2006 046 860.

Besides the principal monomers M4, the monomers M5, the monomers M7, and, where used, the monomers M6, the monomers used for preparing the plastics dispersion may include monomers M8, these being other free-radically polymerizable monomers, different from the monomers of groups M4, M5, M6, and M7.

The groups of monomers involved in this case include a very wide variety of groups. The monomers M8 include, for example, ethylenically unsaturated, nonionic functional monomers, such as the amides of the carboxylic acids cited in connection with the ethylenically unsaturated, ionic monomers. Examples thereof are methacrylamide and acrylamide, and also water-soluble N-vinyl lactams, such as N-vinylpyrrolidone, for example, or else compounds which as ethylenically unsaturated compounds comprise covalently bonded polyethylene glycol units, such as polyethylene glycol monoallyl or diallyl ethers, or the esters of ethylenically unsaturated carboxylic acids with polyalkylene glycols.

Further suitable ethylenically unsaturated, nonionic functional monomers include nitriles of ethylenically unsaturated C₃-C₈-carboxylic acids, such as acrylonitrile and methacrylonitrile. Other monomers which can be used are C₄-C₈-conjugated dienes, such as 1,3-butadiene, isoprene, and chloroprene, or aliphatic, ethylenically unsaturated, optionally halogen-substituted hydrocarbons, such as ethylene, propylene, butylene, vinyl chloride or vinylidene chloride.

Additionally, crosslinkers may be added to the monomers. Monomers include not only compounds which have an acetoacetoxy unit attached covalently to the double-bond system, but also compounds having covalently bonded urea groups. The first-mentioned compounds include, more particularly, acetoacetoxyethyl (meth)acrylate and allyl acetoacetate. The compounds containing urea groups include, for example, N-vinyl- and N-allyl-urea and also derivatives of imidazolidin-2-one, such as N-vinyl- and N-allylimidazolidin-2-one, N-vinyloxyethylimidazolidin-2-one, N-(2-(meth)acryl-amidoethyl)imidazolidin-2-one, N-(2-(meth)acryloyloxyethyl)imidazolidin-2-one, N-(2-(meth)acryloyloxyacetamidoethyl)imidazolidin-2-one, and also further adhesion promoters known to the skilled worker, based on urea or imidazolidin-2-one. Also suitable, for the purpose of improving the adhesion, is diacetoneacrylamide in combination with a subsequent addition of adipic dihydrazide to the dispersion.

Crosslinkers which can be used include both difunctional and polyfunctional monomers. Examples thereof are diallyl phthalate, diallyl maleate, triallyl cyanurate, tetraallyloxyethane, divinylbenzene, butane-1,4-diol di(meth)acrylate, triethylene glycol di(meth)acrylate, divinyl adipate, allyl (meth)acrylate, vinyl crotonate, methylenebis-acrylamide, hexanediol diacrylate, pentaerythritol diacrylate, and trimethylolpropane triacrylate.

The polymers used in accordance with the invention derive from at least 40%, preferably 50% to 90%, by weight of monomers M4. This may constitute one monomer or a mixture of different monomers from this group.

The copolymers used in accordance with the invention further derive from 0.1% to 10% by weight, preferably 1% to 6% by weight, of monomers M5. This may constitute one monomer or a mixture of different monomers from this group.

The polymers used in accordance with the invention further derive from 1% to 15% by weight, preferably 2% to 10% by weight, of monomers M6. This may be one monomer or a mixture of different monomers from this group. The monomers M6 are optional, though their use is preferred. Instead of or in addition to the monomers M6 it is possible to use amino-, mercapto- or epoxide-functionalized alkoxysilane-comprising monomers.

The fraction of the monomers M7 in copolymerized form, based on the polymer (solids), is 0.1% to 10% by weight, preferably 0.5% to 5% by weight. The fraction of the monomers M8 in copolymerized form, based on the polymer, is 0% to 20% by weight, preferably 1% to 15% by weight.

The quantity figures for the monomers are based on the total amount of monomers used in the emulsion polymerization and, where appropriate, for the subsequent addition. The fraction of the monomers copolymerized into the copolymer corresponds generally to the monomers added.

Particular preference is given to a polymer dispersion which is prepared by free-radical emulsion polymerization and which is a homopolymer or copolymer derived from acrylate and/or methacrylate as principal monomer, or is a homopolymer or copolymer derived from vinyl ester as principal monomer, preferably a polyacrylate or a polyvinyl ester having a glass transition temperature T_{g} in the range from −60 to +40° C.

In addition to the copolymerized emulsifiers, the polymer dispersion P used in accordance with the invention may also be stabilized by protective colloids and/or by emulsifiers. These agents may be present during the emulsion polymerization itself or may be added thereafter.

Examples of protective colloids are those specified above and also those disclosed in DE 10 2006 046 860, the teaching of which is hereby expressly incorporated by reference. The weight fraction of such optionally present protective colloids, based on the total amount of the monomers used, is typically up to 15%.

In many cases it is advantageous when preparing dispersions to use nonionic and/or anionic emulsifiers in addition to the protective colloids or instead of protective colloids. Suitable emulsifiers are those specified above and also those disclosed in DE 10 2006 046 860, the teaching of which is hereby expressly incorporated by reference. Similar comments apply to the quantities to be selected.

The aqueous polymer dispersions used in accordance with the invention typically possess solids contents of 20% to 70%, preferably 30% to 65%, more preferably 35% to 60%, by weight.

The polymer dispersions used in accordance with the invention further comprise, if desired, other, conventional additions.

The emulsion polymerization is conducted in accordance with processes known to the skilled worker, more particularly in accordance with the processes described in DE 10 2006 046 860, hereby expressly incorporated by reference. Preference is given to employing single-phase emulsion polymers.

Suitable free-radical polymerization initiators (free-radical initiators) include in principle all of those identified above. It is preferred, however, to use water-soluble persulfates, more particularly ammonium persulfate or sodium persulfate, for starting off the polymerization.

Furthermore, it is also possible to use the abovementioned free-radical chain transfer compounds in order to control the molecular weights of the polymers obtainable through the polymerization.

Emulsifier and/or protective colloid used for stabilization may likewise either be included in its entirety at the start of the polymerization, or part included initially and part metered in, or metered in completely during the polymerization.

The polymerization temperature is situated typically in the range from 20 to 120° C., preferably in the range from 30 to 110° C., and very preferably in the range from 45 to 95° C.

After the conclusion of the polymerization reaction, residual monomers may be removed as described above.

Suitable colloidal silicon dioxide is preferably an aqueous colloidal dispersion or suspension of ultrafine silicon dioxide particles. The diameter of primary particles in this dispersion or suspension is preferably 2 to 100 nm, and the primary particles are spherical. The colloidal silicon dioxide c) used in accordance with the invention is preferably an amorphous silicon dioxide and is either of anionic type or cationic type (=anionic or cationic surface charges of the particles, compensated by corresponding counterions). It is preferred to employ dispersions in which the particles have anionic surface charges and are stabilized by alkali metal or ammonium ions, more particularly by sodium, potassium or ammonium ions. The colloidal silicon dioxide may additionally be a monodisperse or a polydisperse silicon dioxide in which the particles are present individually and/or in the form of aggregates. Colloidal silicon dioxide is available commercially, under the Klebosol or Köstrosol trade names, for example. Furthermore, the silicon-containing compounds identified above are suitable.

The colloidal silicon dioxide is used typically in an amount of 5 to 200 parts by weight, based on the amount of copolymer.

Typically the colloidal silicon dioxide is added to the aqueous polymer dispersion after its preparation and/or during the preparation of the coating material. Addition of the colloidal silicon dioxide after the preparation of the polymer dispersion is particularly preferred. Colloidal silicon dioxide and the polymer together form the composite particles suitable in accordance with the invention.

The composite particles obtained in accordance with this process are constructed from
20% to 60%, preferably 20% to 50%, more particularly 30% to 50%, by weight, based on the composite particle, of inorganic solid having an average particle size of 5 to 100 nm, and
40% to 90%, preferably 50% to 80%, more particularly 50% to 70%, by weight, based on the composite particle, of polymer (solids), obtainable by free-radical emulsion polymerization of the monomers M4, M5, M6, and M7.

Coating Material

A coating composition of the invention comprises, based on the total solids content,
25% to 55%, preferably 30% to 50%, more preferably 35% to 45%, by weight of the abovementioned composite particles, in the form of an aqueous dispersion,
20% to 50% by weight of fillers, with 5% to 40% by weight, based on the total solids content, being selected from aluminum silicates, borosilicate glasses, polymethyl methacrylate particles, and polystyrene particles,
1% to 30% by weight of pigments, and
0% to 5%, preferably 0.01% to 3%, more preferably 0.1% to 2.5%, by weight, of one or more thickeners,
0.1% to 20%, preferably 0.1% to 10%, more preferably 0.1% to 5%, by weight each of other auxiliaries, such as biocides, pigment dispersants, film-forming assistants, and defoamers, for example.
5% to 40% by weight of the filler (identified below as filler (i)), based on the total solids content of the coating material, is selected from aluminum silicates, borosilicate glasses, polymethyl methacrylate particles, and polystyrene particles. Aluminum silicates are obtainable, for example, under the Zeeospheres White Ceramic Microspheres name (3M Speciality Materials). Borosilicate glasses (3M Speciality Materials). Polymethyl methacrylate particles and polystyrene particles are available under the Spheromers and Dynoseeds (Microbeads) brand names.

Preference is given to inorganic fillers (i) such as aluminum silicates and borosilicate glasses.

In another embodiment, preference is given to organic fillers (i), such as polymethyl methacrylate particles and polystyrene particles.

Filler (i) preferably has an average particle size d50 of 3 to 30 μm. Preference is given to aluminum silicates having an average particle size d50 of 3 to 20 μm. Likewise preferred are borosilicate glasses having an average particle size d50 of 15 to 30 μm. Additionally preferred are polymethyl methacrylate particles and/or polystyrene particles each having an average particle size d50 of 6 to 30 μm.

The stated fillers (i) may be used individually or else in a mixture. Preferred is a mixture of at least one inorganic filler with at least one organic filler. Particular preference is given to selecting a mixture of organic filler/inorganic filler in a ratio of 1/4 to 3/1.

Further to fillers (i) there may be other inorganic fillers, different from them (and referred to below as filler (ii)) used.

Examples of suitable further inorganic fillers (ii) include filler particles composed of andalusite, silimanite, kyanite, mullite, pyrophylite, omogolite or allophane. Also suitable are compounds based on sodium aluminates, silicates, such as aluminum silicates such as feldspars having particle sizes d50 of less than 3 μm, calcium silicates or silicas (Aerosil). Likewise suitable are minerals such as siliceous earth, calcium sulfate (gypsum), not originating from flue gas desulfurization plants, in the form of anhydrite, hemihydrate or dihydrate, finely ground quartz, silica gel, precipitated or natural barium sulfate, titanium dioxide, zeolites, leucite, potash feldspar, biotite, the group of the soro-, cyclo-, ino-, phyllo-, and tectosilicates, the group of sparingly soluble sulfates, such as gypsum, anhydrite or heavy spar, and also alkaline earth metal carbonates, such as calcium carbonate, in the form of—for example—calcite or chalk.

The stated inorganic materials may be used individually or else in a mixture. Further suitable materials are precipitated or natural kaolin, talc, magnesium hydroxide or aluminum hydroxide (for adjusting the fire classification), zinc oxide, and zirconium salts. Adding lightweight fillers—hollow ceramic microbeads, hollow glass beads, foamed glass beads or other lightweight fillers, of the kind produced by Omega-Minerals, for example—allows parameters such as dimensional stability and density to be influenced.

In coating materials, of course, finely divided fillers are preferred. The fillers can be used as individual components. In practice, however, filler mixtures have also been found appropriate, examples being calcium carbonate/kaolin and calcium carbonate/talc.

Suitable inorganic fillers (ii) are the Omyacarb® products from Omya and the Finntalc® products from Mondo Minerals, the Celite® and Optimat™ products from World Minerals, and the Aerosil® products from Evonik Industries AG.

The pigments serve to color the coating material. For this purpose, use is made of organic pigments and/or inorganic pigments such as iron oxides. These include inorganic white pigments such as titanium dioxide, preferably in the rutile form, such as the Kronos® products from Kronos, the Tiona® products from Millenium, the TIOXIDE® products from Huntsman, Ti-Pure® products from Du-Pont de Nemours, barium sulfate, zinc oxide, zinc sulfide, basic lead carbonate, antimony trioxide, lithopones (zinc sulfide +barium sulfate) or colored pigments, examples being iron oxides, carbon black, graphite, zinc yellow, zinc green, ultramarine, manganese black, antimony black, manganese violet, Paris blue or Schweinfurt green. Besides the inorganic pigments, the emulsion paints of the invention may also comprise organic color pigments, examples being sepia, gamboge, Cassel brown, toluidine red, para red, Hansa yellow, indigo, azo dyes, anthraquinonoid and indigoid dyes, and also dioxazine, quinacridone, phthalocyanine, isoindolinone and metal-complex pigments. Also suitable are synthetic white pigments with air inclusions for increasing light scattering, such as the Rhopaque® dispersions. The pigments are used in amounts of 1% to 30% by weight, preferably 10% to 25% by weight.

The fraction of the pigments and fillers in a coating material can be described by the pigment volume concentration (PVC). The PVC describes the ratio of the volume of pigments (VP) and fillers (VF) to the total volume made up of the volumes of binder (VB), pigments and fillers in a dried coating film, in percent: PVC=(VP+VF)×100/(VP+VF+VB).

Preferred coating materials are those having a PVC in the range from 50 to 65. The thickeners, generally speaking, are substances of high molecular mass which either absorb water and swell in the process, or form intermolecular lattice structures. The organic thickeners undergo transition, ultimately, to a viscous true or colloidal solution.

Use may also be made of thickeners based on acrylic acid and acrylamide (for example, Collacral® HP), carboxyl-containing acrylic ester copolymers such as Latekoll® D, PU thickeners (for example, Collacral® PU 75), celluloses and derivatives thereof, and also natural thickeners, such as bentonites, alginates or starch, for example.

The thickeners are used in an amount of 0 to 5% by weight, preferably 0.1% to 2.5% by weight.

In summary, the elastic coating material substantially comprises an aqueous composite-particle dispersion. Other auxiliaries may be added in a simple way to the aqueous dispersion.

The other auxiliaries include, for example, preservatives for the purpose of preventing fungal and bacterial infestation, solvents for influencing the open time and the mechanical properties, such as butyl glycol, dispersing aids for improving the wetting behavior, examples being Pigment Dispersant NL (BASF SE, DE), emulsifiers (Emulphor® OPS 25, Lutensol° TO 89), and frost preventatives (ethylene glycol, propylene glycol). Further auxiliaries may be crosslinkers, adhesion promoters (acrylic acid, silanes, aziridines) or defoamers.

The coating materials of the invention are produced in a known way by blending the components in mixing equipment customary for the purpose. It has been found appropriate to prepare an aqueous paste or dispersion from the pigments, water and, where appropriate, the auxiliaries, and only then to mix the polymeric binder, i.e., in general, the aqueous dispersion of the polymer, with the pigment paste or pigment dispersion.

The coating material of the invention can be applied to substrates in a typical way, for example by spreading, spraying, dipping, rolling, knifecoating, etc.

The coating materials of the invention are suitable for coating surfaces, objects or substrates which are in permanent water contact. The materials to which the coating material is applied may be diverse, without any deterioration in adhesion being observed. Suitable materials thus include wood, wood base materials, plastic, stone, concrete, plaster, repair mortar, metallic materials, steel, metal-coated steel, and tiles. The coating materials likewise exhibit effective adhesion on colored coating substrates. The coating material is used preferably for coating cavities filled with water, more particularly swimming pool water. Likewise preferred is its use for coating surfaces, objects or substrates which are in permanent contact with river water or seawater.

Even over a prolonged period of permanent contact with water, more particularly swimming pool water, no softening of the paint or detachment from the substrate is observed.

The coating materials of the invention are notable for ease of handling, good processing properties, and high hiding power. Their pollutant content is low. They have good performance properties—for example, good water resistance, good wet adhesion, good blocking resistance, good recoatability—and exhibit good flow on application. The equipment used is easily cleaned with water.

The examples which follow are intended to illustrate the invention. The percentages in the examples are weight percentages unless otherwise indicated.

Determination of Solids Content

The solids content was generally determined by drying approximately 1 g of the composite-particle dispersion to constant weight in an open aluminum crucible having an internal diameter of about 3 cm in a drying cabinet at 150° C. For the determination of the solids content, two separate measurements were carried out in each case, and the corresponding average was formed.

Determination of Coagulum Content

The coagulum content was determined by filtering approximately 500 g of the aqueous composite-particle dispersion through a 45 μm nylon sieve, weighed prior to the filtration, at room temperature. Following the filtration, the sieve was rinsed with a little deionized water (about 50 ml) and then dried to constant weight in a drying cabinet at 100° C. under atmospheric pressure (about 1 hour). When the sieve had cooled to room temperature, it was weighed again. The amount of coagulum was indicated with the difference between the two weighings, based in each case on the amount of aqueous composite-particle dispersion used for the filtration. Two determinations of the coagulum content were carried out in each case. The figures reported in each of the examples correspond to the average values of these two determinations.

Particle Size Determination

The particle size of the composite particles was determined generally by the method of quasielastic light scattering (DIN-ISO 13321) using a High Performance Particle Sizer (HPPS) from Malvern Instruments Ltd.

pH

The pH was determined generally by means of a Micropal pH538 instrument from Wissenschaftlich-Technische-Werkstätten (WTW) GmbH at room temperature.

a) Preparing an Aqueous Composite-Particle Dispersion

### EXAMPLE 1

In a 2 l four-neck flask equipped with a reflux condenser, a thermometer, a mechanical stirrer, and a metering apparatus, at 20 to 25° C. (room temperature) and at atmospheric pressure under nitrogen atmosphere, and with stirring (200 revolutions per minute), 416.6 g of Nalco® 1144 (40% by weight colloidal silicon dioxide having an average particle diameter of 14 nm [according to the manufacturer's specification]; brand name of Nalco), followed by 10.8 g of a 20% strength by weight aqueous solution of a

C16C18 fatty alcohol ethoxylate having on average 18 ethylene oxide units (Lutensol® AT18; brand name of BASF SE), and subsequently 315.0 g of deionized water, over the course of 5 minutes, were added. The initial-charge mixture was then heated to 70° C.

Prepared in parallel were feed 1, a monomer mixture consisting of 12.6 g of methyl methacrylate and 18.8 g of n-butyl acrylate, feed 2, 2.9 g of (3-methacryloyloxypropyl)-trimethoxysilane, feed 3, an initiator solution consisting of 2.1 g of sodium peroxodisulfate, 5.4 g of a 10% strength by weight aqueous solution of sodium hydroxide, and 193.0 g of deionized water, and feed 4, a monomer mixture consisting of 87.5 g of methyl methacrylate, 131.2 g of n-butyl acrylate, and 2.5 g of hydroxyethyl methacrylate.

The stirred initial-charge mixture at 70° C. was then admixed continuously via a separate feed line with 0.9 g of feed 2 over the course of 90 minutes. In the course of this addition, 45 minutes after the beginning of feed 2, the reaction mixture was heated to a reaction temperature of 85° C. An hour after the start of feed 2, the reaction mixture was fed over the course of a time of 120 minutes via two separate feed lines, beginning simultaneously, with the total amount of feed 1 and with 158.8 g of feed 3, at continuous flow rates. This was followed by the metered addition to the reaction mixture over the course of a time of 120 minutes, via separate feed lines, beginning simultaneously, of the total amount of feed 4 and the remainder of feed 2, and also, within a time of 135 minutes, of the remainder of feed 3, with continuous flow rates. Thereafter the aqueous composite-particle dispersion obtained was stirred at reaction temperature for one hour more and then cooled to room temperature.

The resultant aqueous composite-particle dispersion was translucent and of low viscosity and had a solids content of 35.5% by weight. The pH of the composite-particle dispersion was 9.1. The average size (Z-average) of the composite particles was found to be 117 nm. According to the method of the analytical ultracentrifuge (AUC; in this regard, cf. S. E. Harding et al., Analytical Ultracentrifugation in Biochemistry and Polymer Science, Royal Society of Chemistry, Cambridge, Great Britain 1992, Chapter 10, Analysis of Polymer Dispersions with an Eight-Cell-AUC-Multiplexer: High Resolution Particle Size Distribution and Density Gradient Techniques, W. Mächtle, pages 147 to 175) it was not possible to detect any free silicon dioxide particles.

Formulation of a Coating Material

### EXAMPLE

1. General Instructions for Producing Coating Materials

The individual components (for indication of manufacturer see table 1) were metered in the amount (parts by weight) and sequence as indicated in table 2, with stirring using a toothed-disk stirrer. Following addition of the titanium dioxide pigment, the speed was increased to 2000 rpm and dispersion continued until the paste was smooth, i.e., free from lumps. This gave 66 parts by weight of a paste.

This paste was cooled if necessary to room temperature, and the remaining components, which are listed in table 3, were added in the quantities indicated in that table, and in that order, at a reduced speed. This gave 200 parts by weight of an aqueous coating material.

TABLE 1
Raw materials used

| Function | Name | Manufacturer |
|---|---|---|
| Dispersant | Ultradispers ® AB 30 (Polymer | BASF SE |
| | based on acrylic acid and n- | |
| | butyl acrylate) | |
| Defoamer | Byk 022 (Polysiloxane) | Byk-Chemie |
| | | GmbH, Wesel |
| Titanium dioxide | Kronos ® 2190 | Kronos Titan |
| pigment | | GmbH, Leverkusen |
| Pigment | Heucodur ® Blue 5-100 | Heubach GmbH |
| Pigment | Luconyl Blue 7080 | BASF SE |
| Preservative | Acticide MBS | Thor Chemie GmbH |
| Wetting agent | AMP 90 | Angus Chemie |
| | | GmbH |
| Thickener | Betolin ® V 30 | Woellner GmbH |
| Filler | Omyacarb 2 GU (2 μm) | Omya GmbH |
| Filler | Omyacarb 5 GU (5 μm) | Omya GmbH |
| | Zeeospheres ™ W 610 | 3M Deutschland |
| | (10 μm) (aluminum silicate | GmbH |
| | ceramic) | |
| | Dynoseeds ® TS 40 (40 μm) | Microbeads AS |
| | (polystyrene beads) | |
| Thickener | Collacral ® LR 8990 | BASF SE |
| Thickener | Collacral ® PU 10 W | BASF SE |

TABLE 2
Formulation of the paste of the inventive coating 1

| Component | Name | Amount [g] |
|---|---|---|
| Composite-particle dispersion | | 350 |
| from example 1 | | |
| | AMP 90 | 8 |
| | Acticide MBS | 2 |
| | Ultradispers AB 30 | 10 |
| | Betolin V 30 | 2 |
| Butyl glycol | | 15 |
| Defoamer | Byk 022 | 3 |
| Titanium dioxide pigment | Kronos ® 2190 | 80 |
| | Heucodur Blue 5-100 | 32 |
| | Luconyl Blue 7080 | 4 |
| Total (paste) | | 506 |

TABLE 3
Components of the inventive coating material 1

| Component | | Amount |
|---|---|---|
| Aqueous paste | | 506 |
| Filler | Omyacarb 2 GU | 30 |
| | (2 μm) | |
| Filler | Omyacarb 5 GU | 60 |
| | (5 μm) | |
| Filler | Zeeospheres W 610 | 60 |
| | (10 μm) (aluminum | |
| | silicate ceramic) | |
| Filler | Dynoseeds TS 40 | 36 |
| | (40 μm) (polystyrene | |
| | beads) | |
| | Byk 022 | 2 |
| Thickener | Collacral LR 8990 | 6 |
| Composite-particle dispersion | | 290 |
| from example 1 | | |
| Solvent | White spirit K30 | 10 |
| Total | | 1000 |

TABLE 4
formulation of the paste of the inventive coating 2

| Component | Name | Amount [g] |
|---|---|---|
| Composite-particle dispersion | | 350 |
| from example 1 | | |
| | AMP 90 | 10 |
| | Ultradispers AB 30 | 10 |
| | Betolin V 30 | 1 |
| Butyl glycol | | 5 |
| Defoamer | Byk 022 | 3 |
| Titanium dioxide pigment | Kronos ® 2190 | 40 |
| | Heucodur Blue 5-100 | 40 |
| | Luconyl Blue 7080 | 1 |
| Total (paste) | | 460 |

TABLE 5
Components of the inventive coating material 2

| Component | | Amount |
|---|---|---|
| Aqueous paste | | 460 |
| Filler | Omyacarb 2 GU (2 | 30 |
| | μm) | |
| Filler | Omyacarb 5 GU (5 | 37 |
| | μm) | |
| Filler | Zeeospheres W 610 | 78 |
| | (10 μm) (aluminum | |
| | silicate ceramic) | |
| Filler | Dynoseeds TS 40 (40 | 36 |
| | μm) (polystyrene | |
| | beads) | |
| Preservative | Copper(I) oxide | 2 |
| Pigment | Zinc oxide | 20 |
| | Byk 022 | 2 |
| Thickener | Collacral PU 10 W | 13 |
| Composite-particle dispersion | | 314 |
| from example 1 | | |
| Solvent | White spirit K30 | 8 |
| Total | | 1000 |

In the same way as for this formulation, coating materials having good performance properties can be formulated using the dispersions described in examples 1, 3, 5, and 10 of DE 10 2006 046 860.

TABLE 6
Formulation of the paste for the comparative paint

| Component | Name | Amount [g] |
|---|---|---|
| | Water | 100 |
| | Ultradispers AB 30 | 10 |
| Preservative | Parmetol A26 | 3 |
| Defoamer | Byk 022 | 3 |
| Butyl glycol | | 25 |
| Preservative | Protectol PP | 10 |
| Propylene glycol | | 25 |
| Thickener | Collacral LR8989 | 16 |
| Titaniun dioxide pigment | Kronos ® 2190 | 80 |
| | Heucodur Blue 5-100 | 32 |
| | Luconyl Blue 7080 | 4 |
| Total (paste) | | 308 |

TABLE 7
Components of the comparative paint

| Component | | Amount |
|---|---|---|
| Aqueous paste | | 308 |
| Filler | Finntalc M15 | 30 |
| Filler | Omyacarb 5 GU | 60 |
| | (5 μm) | |
| Filler | Sikron F 500 finely | 130 |
| | ground quartz | |
| Defoamer | Byk 022 | 2 |
| Thickener | Collacral LR 8990 | 6 |
| Hydrophobic, self-crosslinking | Acronal A706 | 439 |
| acrylate dispersion | | |
| Hydrophobicizing agent | Poligen WE 1 | 25 |
| Total | | 1000 |

Test for Determining the Water Resistance

The coatings of the invention were applied by spreading or rolling to porcelain tiles and were dried in the air for 2 days. They were then stored in a depth of 5 cm of mains water in a plastic can for at least 4 weeks. The measurement of the color values after water storage must take place after the paint has fully dried through. The coatings were tested by measurement of the color in accordance with DIN 6174: “Colorimetric evaluation of color coordinates and color differences according to the approximately uniform CIELAB color space” before and after water storage (L*a*b* color values) to give a storage-induced color difference ΔE=root ((L₁−L₂)̂2+(a₁−a₂)̂2+(b₁−b₂)̂2). A further evaluation was made visually for any blistering or detachment of the coating from the substrate.

A further test took place by scratching with the fingernail, for mechanical resistance of the coating after water storage.

Test Criteria:
1) ΔE: The storage-induced color difference ought, for a good paint, to be less than 1.
2) Adhesion/blistering:
   Rating 1—no blistering
   Rating 2—few small blisters<5 mm Ø
   Rating 3—numerous blisters<1 cm Ø
   Rating 4—numerous large blisters>1 cm Ø
   Rating 5—paint has detached entirely
3) Scratch resistance
   Rating 1—no damage by scratching
   Rating 2—minimal damage
   Rating 3—minor damage about 5 mm Ø
   Rating 4—larger area detached>1 cm Ø
   Rating 5—paint can be detached entirely

The inventive paint according to tables 2 and 3 received the following evaluation after 4 weeks of water storage:

ΔE=1; 2 adhesion/blistering 1; scratch resistance 1-2

The inventive paint according to tables 4 and 5 received the following evaluation after 4 weeks of water storage:

ΔE=0.8; adhesion/blistering 1; scratch resistance 1-2

The comparative paint according to tables 6 and 7 received the following evaluation after water storage:

ΔE=2.5; adhesion/blistering 3; scratch resistance 4

1. A coating material in the form of an aqueous composition comprising:
25% to 55% by weight of composite particles having an average particle size of 50 to 350 nm, in the form of an aqueous dispersion, which are constructed of
20% to 60% by weight, based on the composite particle, of inorganic solid having an average particle size of 5 to 100 nm,
40% to 90%, preferably 40% to 80%, by weight, based on the composite particle, of a polymer matrix having a T_{g} in the range from −60 to +40° C. and obtainable by free-radical emulsion polymerization of at least one ethylenically unsaturated monomer, and
20% to 50% by weight of fillers, with 5% to 40% by weight, based on the total solids content, being selected from aluminum silicates, borosilicate glasses, polymethyl methacrylate particles, and polystyrene particles,
1% to 30% by weight of pigments, and
0% to 5% by weight of one or more thickeners
0.1% to 20% by weight of other auxiliaries
based in each case on the total solids content.

2. The coating material according to claim 1, wherein the inorganic solid is a silicon compound.

3. The coating material according to claim 1 or 2, wherein the polymer matrix of the composite particles is constructed from monomers selected from esters of α,β-ethylenically unsaturated monocarboxylic and dicarboxylic acids with C₁-C₂₀ alkanols, vinylaromatics, esters of vinyl alcohol with C₁-C₁₈ monocarboxylic acids, ethylenically unsaturated nitriles, C₂-C₈ monoolefins, nonaromatic hydrocarbons having at least two conjugated double bonds, ethylenically unsaturated monomers having at least one acid group, and ethylenically unsaturated monomers having at least one amino, amido, ureido or N-hetero-cyclic group, and/or their alkylated ammonium derivatives protonated on the nitrogen, or ethylenically unsaturated monomers which contain at least one silicon-containing functional group (silane monomers).

4. The coating material according to any of claims 1 to 3, wherein the composite particles are constructed by free-radical emulsion polymerization of ethylenically unsaturated monomers comprising 0.01% to 10% by weight, based on the total monomers, of an ethylenically unsaturated monomer containing a silicon-containing functional group (silane monomer).

5. The coating material according to any of claims 1 to 4, wherein the composite particles are constructed by free-radical emulsion polymerization in which ethylenically unsaturated monomers are dispersed in an aqueous medium and polymerized by means of 0.05% to 2% by weight of at least one free-radical polymerization initiator in the presence of 1% to 1000% by weight of at least one dispersed, finely divided inorganic solid, based in each case on the total monomer amount, and at least one dispersing assistant, by
a) including at least a portion of the inorganic solid in an initial charge in an aqueous polymerization medium, in the form of an aqueous dispersion of solids, and subsequently metering in 0.01% to 20% by weight of the total monomer amount and at least 60% by weight of the total amount of free-radical polymerization initiator, and polymerizing the added monomers under polymerization conditions to a monomer conversion ≧80% by weight (polymerization stage 1), and subsequently
b) metering any remainder of the inorganic solid, any remainder of the free-radical polymerization initiator, and the remainder of the monomers into the polymerization mixture of stage 1 under polymerization conditions and continuing polymerization to a monomer conversion ≧90% by weight (polymerization stage 2).

6. The coating material according to claim 5, wherein the total amount of the inorganic solid is included in the initial charge in step a) of the process. 30

7. The coating material according to claim 5 or 6, wherein first only ≧5% and ≦70% by weight of the total amount of the silane monomers is metered into the aqueous dispersion of solids in step a) of the process, over a period of 5 to 240 minutes, and subsequently any remaining, other ethylenically unsaturated monomers and the free-radical polymerization initiator are metered in.

8. The coating material according to any of claims 5 to 7, wherein an anionic and/or a nonionic emulsifier is used as dispersing assistant.

9. The coating material according to any of claims 1 to 8, wherein the pigment volume concentration is in the range from 50 to 65.

10. A swimming pool paint comprising, as binder, composite particles according to any of claims 1 to 9.

11. The use of the coating material according to claims 1 to 9 for coating surfaces, objects or substrates which are in permanent water contact.

12. The use of the coating material according to claims 1 to 9 for coating cavities filled with swimming pool water.
